(19) United States
(12) Patent Application Publication
(10) Pub. No.: US 2014/0307727 A1
(43) Pub. Date: Oct. 16, 2014

(54) APPARATUS AND METHOD FOR SYNCHRONIZATION BETWEEN DEVICES

(71) Applicant: Samsung Electronics Co., Ltd., Gyeonggi-do (KR)

(72) Inventors: Kyung-Hoon CHA, Seoul (KR); Seong-Woon KANG, Gyeonggi-do (KR); Young-Woong KIM, Seoul (KR); Sung-Jin PARK, Seoul (KR); Kyu-Suk LEE, Gyeonggi-do (KR); Jong-In LEE, Gyeonggi-do (KR)

(73) Assignee: Samsung Electronics Co., Ltd., Gyeonggi-do (KR)

(21) Appl. No.: 14/186,484

(22) Filed: Feb. 21, 2014

(30) Foreign Application Priority Data
Apr. 16, 2013 (KR) 10-2013-0041562

(51) Int. Cl. H04W 56/00; G06F 3/01

(52) U.S. Cl. CPC H04W 56/00; G06F 3/017
USPC 370/350

(57) ABSTRACT

An apparatus and method for mediating synchronization between devices are provided. The apparatus includes a short-distance communication section for implementing wireless communication, and a control section that transmits first synchronization request information to a first device through the short-distance communication section, receives device identification information from the first device, and transmits second synchronization request information to a second device after confirming the first device as a master device.

### PRIORITY

This application claims priority under 35 U.S.C. §119(a) to Korean Application Serial No. 10-2013-0041562, which was filed in the Korean Intellectual Property Office on Apr. 16, 2013, the entire content of which is incorporated herein by reference.

### BACKGROUND OF THE INVENTION

1. Field of the Invention

The present invention relates generally to an apparatus and method for synchronization between devices, and more particularly to an apparatus and a method that synchronizes devices different from each other through a mediation device.

2. Description of the Related Art

Progressive wireless communication applied technologies made by combining a contactless authentication based on RFID related technologies among wireless communication technologies and Ad-Hoc networking technologies are used for synchronizing devices between each other.

Synchronization between devices is implemented through a process of searching for information about surrounding devices, and a process of setting complicated environments for respective devices. Specifically, a master device for transmitting data and a slave device for receiving data are determined through a process of setting the complicated environments, and synchronization is implemented between the master device and the slave device so that information exchange and interactions between devices may be performed.

Conventional synchronization between devices is implemented by searching for information about surrounding devices which could implement synchronization, then carrying out a complicated setup procedure in respective devices requiring the synchronization.

However, the number of devices requiring synchronization has increased gradually, and methods for implementing synchronization are different for respective devices. Therefore, problems arise in that it is difficult to implement synchronization between devices.

Also, conventionally, it is very inconvenient for users to search for and select directly devices requiring synchronization among surrounding devices, after confirming a list about surrounding devices with a user's eye one by one for implementing synchronization between devices.

### SUMMARY OF THE INVENTION

The present invention has been made to address at least the above problems and disadvantages, and to provide at least the advantages described below. Accordingly, an aspect of the present invention provides an apparatus and a method that implements synchronization between devices briefly and rapidly.

According to an aspect of the present invention, a method for synchronization between devices includes transmitting first synchronization request information by a mediation device to a first device, according to a first gesture of the mediation device with respect to the first device; receiving device identification information, which corresponds to the first synchronization request information, from the first device; and implementing synchronization between the first device and a second device through transmission of second synchronization request information to the second device by the mediation device, according to a second gesture of the mediation device with respect to the first device and the second device.

According to another aspect of the present invention, a method for synchronization between devices includes receiving first synchronization request information from a mediation device by a first device, according to a first gesture of the mediation device with respect to the first device; transmitting device identification information of the first device to the mediation device by the first device in response to the first synchronization request information; and transmitting images displayed on a screen of the first device to a second device, according to a second gesture of the mediation device with respect to the second device different from the first device, when synchronization between devices is implemented.

According to still another aspect of the present invention, a method for synchronization between devices includes receiving second synchronization request information from a mediation device by a second device, according to a second gesture of the mediation device with respect to the second device, the second synchronization request information including device identification information obtained by the mediation device from a first device according to a first gesture of the mediation device with respect to the first device; and receiving from the first device an image displayed on a screen of the first device by the second device using the second synchronization request information to thereby display the image on a screen of the second device.

According to another aspect of the present invention, an apparatus for mediating synchronization between devices includes a short-distance communication section that implements wireless communication; and a control section that transmits first synchronization request information to a first device through the short-distance communication section, receives device identification information from the first device, and transmits second synchronization request information to a second device after confirming the first device as a master device.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating synchronization between devices by using a synchronization mediation apparatus according to an embodiment of the present invention;

FIG. 2A illustrates a constitution of a mediation device for performing synchronization between devices according to an embodiment of the present invention;

FIG. 2B illustrates a constitution of a mediation device for performing synchronization between devices according to another embodiment of the present invention;

FIG. 2C illustrates respective constitutions of a first device and a second device according to an embodiment of the present disclosure;

FIG. 3 is a flowchart illustrating an operation of a mediation device for performing synchronization between two devices according to an embodiment of the present invention;

FIG. 4 is a flowchart illustrating an operation of the mediation device for performing synchronization between devices according to another embodiment of the present invention;

FIG. 5 is a signal flow diagram illustrating a process for transmitting and receiving data performed by the mediation device for performing synchronization between devices according to an embodiment of the present invention; and

FIGS. 6A and 6B illustrate a method for performing synchronization between devices by gestures according to an embodiment of the present invention.

Throughout the drawings, the same drawing reference numerals will be understood to refer to the same elements, features and structures.

### DETAILED DESCRIPTION OF EMBODIMENTS OF THE PRESENT INVENTION

A detailed description of the present invention will be given below with reference to the accompanying drawings illustrating for specific embodiments implementing the present invention. The embodiments will be sufficiently described in detail such that those skilled in the art may carry out the present invention. It should be understood that although various embodiments of the present invention are different from each other, they need not be mutually exclusive. For example, in regard to an embodiment, specific forms, structures, and characteristics described herein may be realized through another embodiment without departing from the spirit and scope of the present invention. Moreover, it should be understood that locations or arrangements of separate elements within the disclosed embodiments can be changed without departing from the spirit and scope of the present invention. Accordingly, detailed descriptions which will be given below are not intended to be restrictive, and the scope of the present invention should be limited only by the accompanying claims and equivalents thereof. Similar reference numerals shown in the drawings denote elements performing an identical or similar function in several aspects.

In the following description of the present invention, a detailed description of known functions and configurations incorporated herein will be omitted when it may make the subject matter of the present disclosure unclear.

According to embodiments of the present invention, synchronization may be easily performed between devices different from each other through the mediation device, based on a simple gesture of a user or a gesture of the mediation device.

Also, according the embodiments of the present invention, synchronization may be performed simply through the mediation device without any complicated setup procedure between various devices.

In this instance, a mediation device according to one embodiment of the present invention performs communication via at least one of Near Field Communication (NFC), Radio Frequency Identification (RFID), Wireless Personal Area Network (WPAN), RuBee, ZigBee, Ultra Wide Band (UWB), Bluetooth, WiFi-direct, and Infrared Data Association (IrDA).

In the present invention, a first device and a second device are prepared for a communication setup in order to perform communication with a mediation device, and the mediation device performs synchronization between the first device and the second device by sequentially transmitting a Group identity to the first device and the second device.

First synchronization request information, which is transmitted to the first device by the mediation device according to an embodiment of the present invention, includes request information to set the first device as a master device. Also, the first synchronization request information which is transmitted by the mediation device to the second device, includes request information to set the second device as a slave device.

Meanwhile, the mediation device according to the embodiment of the present invention receives identification information including address information for the communication section of the first device and master device setup confirmation information, after it transmits first synchronization request information to the first device.

Accordingly, synchronization between the devices may be simply performed by the mediation device in the respective devices, which are subjected to synchronization, without searching for the devices which may be synchronized, and without a separate confirmation and setup.

For example, synchronization between the first and second devices may be performed through the setup of the master device by enabling the mediation device around the first device intended to be synchronized, and setting the slave device by enabling it around the second device.

In addition, as another example of the present invention, the mediation device according to the present invention performs synchronization simply by setting the first device as the master device and setting a plurality of second devices as the slave devices. Therefore, when the master device transmits data, the plurality of slave devices receive the same data.

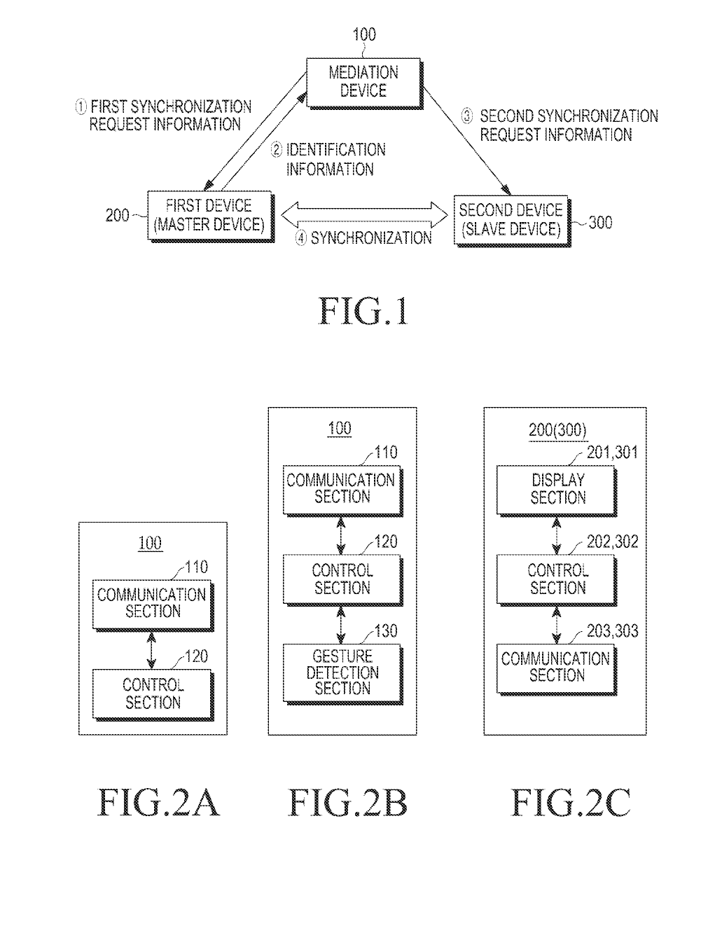

FIG. 1 is a block diagram illustrating synchronization between devices by using a mediation device for synchronization between the devices according to one embodiment of the present disclosure.

Referring to FIG. 1, the mediation device 100 according to an embodiment of the present invention, transmits first synchronization request information to a first device 200, receives device identification information corresponding to the first synchronization request information, and then transmits second synchronization request information to the second device 300, thereby performing a synchronization process between the devices. The first synchronization request information, which is transmitted to the first device 200 by the mediation device 100, may include a master device setup information for setting the first device 200 as a master device, and address request information for requesting address information of the first device 200. The master device setup information includes information for requesting the first device 200 to act as the master device for transmitting data, when the first device 200 is synchronized with the second device 300. Also, the address request information includes at least one of a Media Access Control (MAC) address and a Service Set IDentification (SSID) of the first device 200.

Also, the device identification information, which is received from the first device 200 by the mediation device 100, includes master device setup confirmation information and address information of the first device 200. The master device setup confirmation information includes information which enables the user to identify if the first device 200 is set to be the master device according to the information about the setup of the master device. The address information includes at least one of the MAC address and the SSID of the first device 200 according to the address request information.

Also, the second synchronization request information, which is transmitted to the second device 300 by the mediation device 100, includes slave device setup information about whether or not the second device 300 is set to be a slave device, and identification information of the first device 200. The slave device setup information includes information which requests that the second device 300 is set to be the slave device for receiving the data transmitted from the first device 200 when the second device 300 is synchronized with the first device 200. The device identification information may include any one of the MAC address and the SSID of the communication section of the first device 200.

The mediation device 100 may communicate with the first and the second devices 200 and 300 by using at least one communication scheme including Near Field Communication (NFC), Radio Frequency Identification (RFID), Wireless Personal Area Network (WPAN), RuBee, ZigBee, Ultra Wide Band (UWB), Bluetooth, WiFi-direct, and Infrared Data Association (IrDA).

Furthermore, the mediation device 100 performs communication with the first device 200 and the second device 300 based on a relative gesture with respect to the first device 200 and the second device 300. For example, if the mediation device 100 senses a predetermined gesture from the first device 200, the mediation device 100 transmits the first synchronization request information to the first device 200 by detecting the gestures. Also, in a case in which a predetermined gesture is performed in direct contact with a display section (not shown) provided in the first device 200 or is in a state of hovering at a close distance (e.g., a distance within 10 cm from the display section of the first device 200) from the display section of the first device, the mediation device 100 detects the predetermined gesture, and may determine that user input is inputted in response to the detected gesture. Then, the mediation device 100 transmits the first synchronization request information to the first device 200 in response to the input of the detected user input. Also, when a predetermined gesture is performed around the first device 200 or on the display section (not shown) of the first device 200 by the mediation device 100, the first device detects the predetermined gesture, receives the first synchronization request information from the mediation device 100 in response to the detected gesture, and transmits the device identification information to the mediation device 100 in response to the gesture.

The mediation device 100 receives from the first device 200 the device identification information of the first device 200, and transmits the received device identification information and the second synchronization request information to the second device 300 which is different from the first device 200. The second device 300 may be any one device or a plurality of devices selected by users of a plurality of surrounding devices located and spaced from the first device 200. For example, when a user performs the predetermined gesture around the second device 300 or on the display section (not shown) of the second device 300, with carrying the mediation device 100, the mediation device 100 detects the predetermined gesture, and provides the device identification information of the first device 200 and the second synchronization information to the second device 300 based on the detected gesture. Also, in a case in which the mediation device 100 senses a predetermined gesture from the surrounding second device 300 or on the display section of the second device 300, the second device 300 detects the predetermined gesture, and then requests the device identification information of the first device 200 from the mediation device 100 based on the detected gesture, and receives the device identification information from the mediation device 100 as a response for the request. Thus, when the second device 300 receives the device identification information of the first device 200, the second device 300 performs synchronization with the first device 200 through a predetermined communication scheme by using the received device identification information. When such synchronization is completed, the first device 200 and the second device 300 perform data communication with each other through the predetermined communication scheme.

With reference to FIG. 1, the process of performing synchronization between the first and second devices 200 and 300 is described by way of example of two devices such as the first and second devices 200 and 300. However, those skilled in the art may easily understand that sequential synchronization between three or more devices may be easily performed. In addition, the terms “first” and “second” are merely intended to differentiate different devices from each other, and does not limit any sequence of them.

FIG. 2A is a diagram illustrating a constitution of the mediation device for performing synchronization between devices according to an embodiment of the present invention, and FIG. 2B is a diagram illustrating a constitution of a mediation device for performing synchronization between devices according to another embodiment of the present disclosure.

Referring to FIG. 2A, a mediation device 100 according to an embodiment of the present invention may include a communication section 110 and a control section 120.

The communication section 110 performs data transmission and reception by using a wireless communication scheme, wherein any one of NFC, RFID, WPAN, RuBee, Zigbee, UWB, Bluetooth, WiFi-direct, and IrDA may be utilized as a wireless communication scheme.

The control section 120 controls the general operation of the communication section 110, and if the mediation device 100 is located within a distance in which it may perform communication with the first or second device 200 or 300, it starts communication by setting up communication between the communication section 110 and the communication section of the first or second device 200 or 300 to transmit first or second synchronization request information to the first or second device 200 or 300, respectively. In this regard, when NFC is used as the wireless communication scheme, it is possible to perform communication between devices located at a close distance within 10 cm. Also, when IrDA is used as the wireless communication scheme, it is possible to perform communication between devices located at a distance within 1 m, and when RuBee is used as the wireless communication scheme, it is possible to perform communication between devices located at a distance within 15 m.

Also, the control section 120 generates first synchronization request information and transmits it to the first device 200. The first synchronization request information may include master device setup information, which requests the first device 200 to be set as the master device for transmitting data to the second device 300, when the first device 200 is intended to be synchronized with another device, such as the second device 300, and address request information, which requests address information of the first device 200. In this regard, the address information may include any one of a MAC address and an SSID of the communication section of the first device 200.

In addition, the control section 120 receives device identification information from the first device 200. In this regard, the device identification information may include master device setup confirmation information in which whether the master device is set or not is confirmed, in response to the master device setting information, and address information in response to the address request information. Here, as the descriptions about the master device setup information and the address information are the same as those explained above in detail with reference to FIG. 1, they will be omitted below.

Also, the control section 120 generates the second synchronization request information and transmits it to the second device 300, and includes slave device setting information that requests the second device 300 to be set as a slave device, which receives data from the first device 200, when the second device 300 is synchronized with the first device 200, and address information of the first device 200. In this regard, the address information may include any one of a MAC address and an SSID of the first device 200.

Referring to FIG. 2B, the mediation device 100 includes a communication section 110, a control section 120, and a gesture detection section 130 according to another embodiment of the present invention.

The control section 120 of the mediation device 100 controls the operations of the communication section 110 through a gesture inputted to the gesture detection section 130. In this regard, the gesture detection section 130 is provided with at least one of a geomagnetism sensor, an acceleration sensor, and a gravity sensor, so that it may detect a gesture of the mediation device 100. When a gesture is detected, the control section 120 performs communication with the first device 200 or the second device 300 by using the communication section 110 based on detected gesture input information.

In this regard, when the mediation device 100 employs an NFC scheme, the control section 120 enables the communication section 110 to be always ready for communication in the NFC scheme, and generates the first synchronization request information which is to be transmitted to the first device 200 when it moves close to the mediation device 100, and then the first device 200 awaits reception of a gesture input signal from the gesture detection section 130. When the gesture input signal is detected from the gesture detection section 130, the control section 120 transmits the first synchronization request information to the first device 200 by using the communication section 110, and receives device identification information from the first device 200.

Also, when the second device 300 comes close to the mediation device 100, the mediation device 100 generates second synchronization request information to be transmitted to the second device 300, and awaits reception of a gesture input signal from the gesture detection section 130. When a gesture signal is detected by the gesture detection section 130, the control section 120 transmits the device identification information, which is transmitted to the first device 200, to the second device 300 by using the communication section 110.

For instance, if a user brings the mediation device 100 close to the first device 200, the mediation device 100 generates first synchronization request information, which is intended to be transmitted to the first device 200, and maintains a waiting state to receive additional input.

Next, when a user waves the mediation device 100 in an upward or downward direction (for example, in a direction going away from a surface of a display section of the first device 200 or moving close to it) close to the first device 200, or rotates the mediation device in one direction (for example, in a clockwise direction), the control section 120 starts communication to transmit the first synchronization request information to the first device 200, and receives device identification information from the first device 200 based on the first synchronization request information.

Then, when a user brings the mediation device 100 close to the second device 300, the control section 120 generates second synchronization request information which is intended to be transmitted to the second device 300, and maintains a waiting state being able to receive additional input.

Next, when a user waves the mediation device 100 in a right or left direction (for example, in a direction parallel to the surface of the display section of the second device 300) or rotates it in another direction (for example, in a counterclockwise direction), the mediation device 100 enables communication, to thereby transmit second synchronization request information to the second device 300.

Thus, the mediation device 100 discerns the first synchronization request information and the second synchronization request information based on types of gestures of the mediation device 100.

Therefore, while a master device and a slave device are already set up among a plurality of devices located around the mediation device 100, the mediation device 100 may enable other devices to be set as a master device and a slave device based on predetermined gestures. Also, it is possible to change any device already set up as a master device into a slave device and a slave device into a master device based on predetermined gestures.

In addition, when the second synchronization request information is generated, device identification information of the first device 200 may be included.

Furthermore, while some examples of gestures sensed by the mediation device 100, which are intended to generate the first and second synchronization request information, have been described, the gestures may be changed.

Also, in the above embodiment, while the mediation device 100 senses one directional gesture of the mediation device 100 near the first device 200 and enables communication, and senses another directional gesture of the mediation device 100 adjacent the second device 300, to thereby enable communication for synchronization, the mediation device 100 may also sense an identical gesture of the mediation device 100 adjacent the first and second devices 200 and 300 to thereby enable communication for the synchronization.

In addition, the mediation device 100 transmits a first synchronization request information to the first device 200, receives identification information from the first device 200, and transmits second synchronization request information to a plurality of second devices 300. For instance, synchronization may be performed by setting a teacher's device (first device) as a master device by means of the mediation device 100, and setting remaining devices (second devices) of students as slave devices, while a class is conducted in a school. Here, the students' devices may be set as slave devices through predetermined gestures discerned by the mediation device 100 concurrently, and sequentially they may be set as slave devices.

FIG. 2C is a diagram illustrating a constitution of the first and second devices according to an embodiment of the present invention.

Each of the first and second device 200 and 300 includes display sections 201 and 301, control sections 202 and 302, and communication sections 203 and 303, respectively.

The first and second devices 200 and 300 perform communication with the mediation device 100 through communication sections 203, 303.

The first device 200 receives the first synchronization request information to thereby be set as a master device, and transmits identification information including address information of the communication section 203 of the first device 200.

Also, the second device 300 receives second synchronization request information to thereby be set as a slave device, and is synchronized through communication connection with the first device 200 based on the identification information of the first device 200. Here, when synchronization is performed, the display sections 201 and 301 provided at the first and second devices may be provided, so that an image identical with that shown in the display section 201 of the master device may be displayed in the display section 301 of the slave device automatically.

Meanwhile, it should be understood that respective constitutional elements of the devices are shown in separate drawings to illustrate that they may be separated functionally and logically; however, it is not meant that they are necessarily separate constitutional elements physically or realized in separate codes.

For reference, each functional section (or module) in the specification may be meant for a functional and structural combination of hardware for carrying out the technical idea of the present invention and software for driving the above hardware. For instance, it should be easily understood by those skilled in the art that each functional section may be meant for a unit of any desired code and any logical code of a hardware resource for carrying out the desired code, and it is not meant for a code physically connected or meant for a sole hardware.

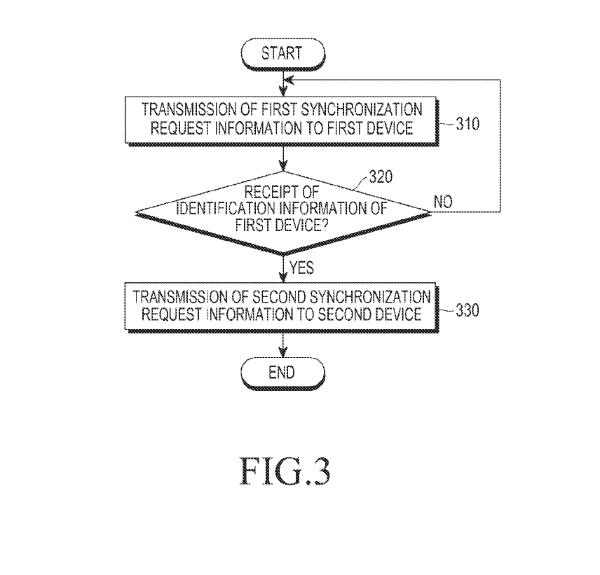

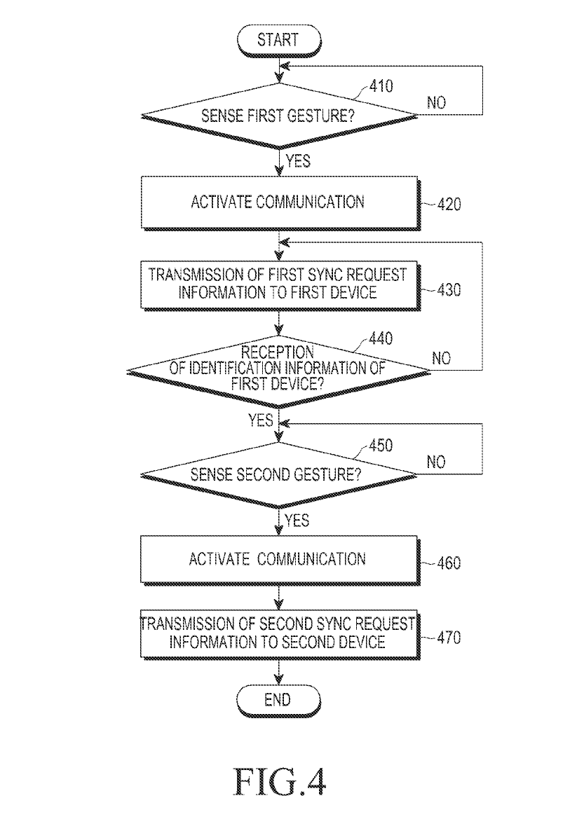

Hereinafter, a method for synchronization between two or more devices will be described with reference to FIGS. 3 to 5.

FIG. 3 is a flowchart illustrating operations of a mediation device for performing synchronization between two or more devices according to an embodiment of the present invention. Referring to FIG. 3, a control section 120 of the mediation device 100 at first transmits first synchronization request information to a first device 200 in step 310.

Then, the control section 120 determines whether device identification information is received from the first device 200 in step 320. Meanwhile, the control section 120 transmits first synchronization request information to the first device 200 again, if the device identification information was not received for a desired time after the transmission of the first synchronization request information to the first device.

The control section 120 then transmits second synchronization request information to the second device 300 so that the first device 200 may be synchronized with the second device 300 in step 330, when the device identification information was received from the first device 200 in step 320. In this instance, the second synchronization request information may include device identification information of the first device 200.

Thus, synchronization between the first device 200 and the second device 300 may be easily performed through the mediation device 100.

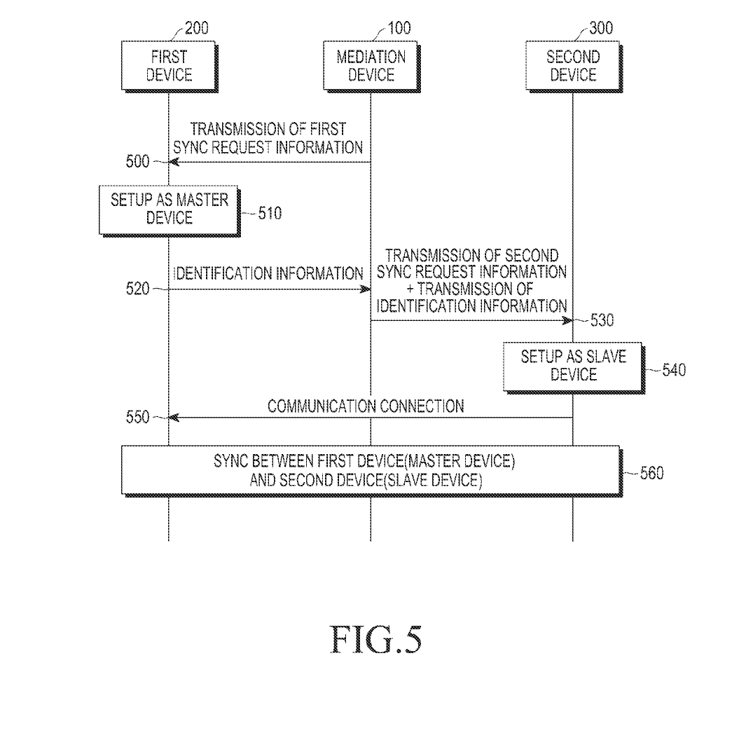

FIG. 4 is a flowchart illustrating operation of a mediation device for performing synchronization between two or more devices according to another embodiment of the present invention.

Referring to FIG. 4, a control section 120 of the mediation device 100 determines at first whether a first gesture sensed by the mediation device 100 is detected by using gesture detection section 130 in step 410. At this time, the first gesture may be detected by the gesture detection section 130 as a motion for activating the communication section 110 so that the mediation device 100 may perform communication with a first device 200. The detected gesture is transmitted to the control section 120 from the gesture detection section 130, and the control section 120 determines whether the detected gesture is the first gesture for performing communication with the first device 200. At this time, the control section 120 may standby until the first gesture is received, if it is not received in step 410.

The control section 120 activates the communication section 110 so that it performs communication with the first device 200, when the first gesture is detected by the gesture detection section 130 in step 420. At this time, the control section 120 transmits first synchronization request information to the first device 200 through the enabled communication section 110 in step 430.

Then, the control section 120 determines whether the device identification information corresponding to the first synchronization request information is received from the first device 200 in step 440. Meanwhile, the control section 120 transmits the first synchronization request information to the first device 200 again when the identification information is not received, after it waits for the reception of the device identification information for a desired time.

Also, the control section 120 may change the communication section 110 from the activation state to the waiting state, when the identification information is received from the first device 200.

Then, the control section 120 determines whether the second gesture of the mediation device 100 is detected by using the gesture detection section 130 in step 450. In this instance, the second gesture activates the communication section 110 so that the mediation device 100 performs communication with the second device 300, and it is detected by the gesture detection section 130 and transmitted to the control section 120. Then, the control section 120 determines whether the detected gesture is a gesture to perform communication with the second device 300. At this time, the control section 120 may await reception of the second gesture until it is received, if it is not received.

The control section 120 enables the communication section 110 so that it performs communication with the second device 300 when the second gesture is detected by the gesture detection section 130 in step 460. At this time, the control section 120 completes the process by transmitting the second synchronization request information to the second device 300 through the activated communication section 110 in step 470.

Also, the identification information of the first device 200 may be included in the second synchronization request information.

Thus, synchronization between the first device 200 and the second device 300 may be easily performed through a simple gesture sensed by the mediation device 100.

Also, a process of synchronization may be easily performed by selecting a first device and a second device of a plurality of devices through a mediation method between devices.

FIG. 5 is a signal flow diagram illustrating a process of transmitting and receiving data between devices by a mediation device, which performs synchronization between devices according to an embodiment of the present invention. Referring to FIG. 5, the mediation device 100 at first transmits first synchronization request information to the first device 200 in step 500.

The first device 200 is set up as a master device in step 510 to transmit data to the second device 300 based on the received first synchronization request information, and transmits identification information including address information of the communication section provided at the first device 200 in step 520. Then, the mediation device 100 transmits the second synchronization request information and identification information of the first device 200 to the second device 300 in step 530.

The second device 300 is set up as a slave device in step 540 according to the received second synchronization request information so that it receives data from the first device 200 when the synchronization is performed, and may be synchronized with the first device 200 by performing communication with the first device 200 in step 550 based on the device identification information of the received first device 200 in step 560.

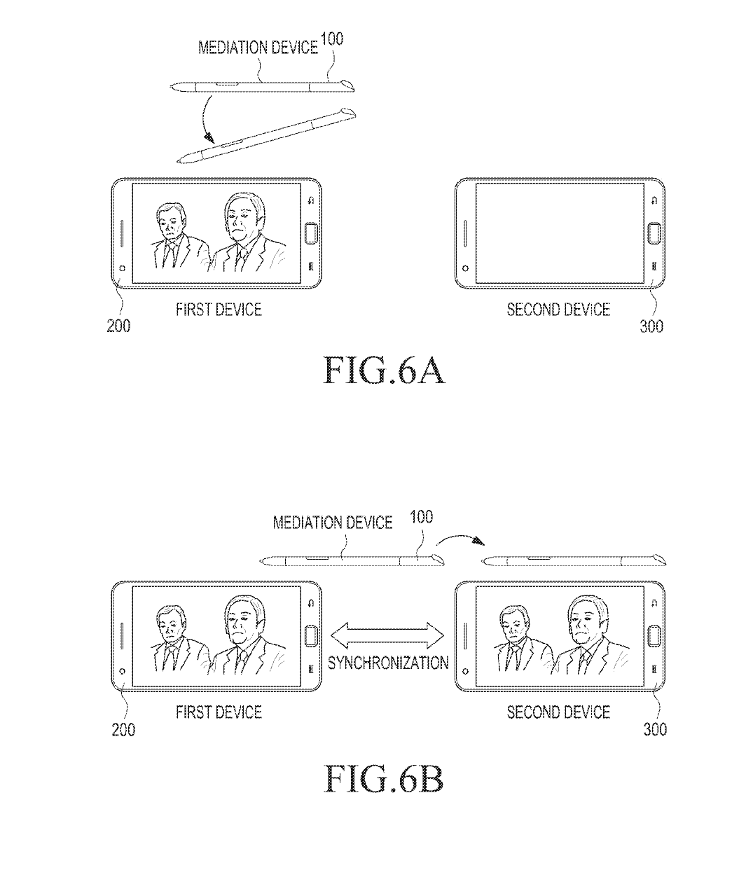

FIGS. 6A and 6B are sequential views illustrating a method of synchronization between devices based on a gesture according to an embodiment of the present invention. Referring to FIG. 6A, when a mediation device 100 is enabled at first to perform communication by using a gesture according to an embodiment of the present invention, it is moved close to the first device 200 to thereby sense a desired gesture (for example, a gesture in an upward or downward direction) for enabling communication with the first device, and then it transmits first synchronization request information to the first device, and receives identification information from the first device.

Then, referring to FIG. 6B, when the mediation device 100 moves close to the second device 300 to thereby sense a desired gesture (for example a gesture in a right or left direction) for activating communication with the second device 200, it transmits second synchronization request information to the second device 200 to thereby complete synchronization between devices.

Thus, not only may synchronization between the first device and the second device be simply performed, but synchronization between a plurality of various devices may also be simply performed through an apparatus and a method for synchronization between devices according to various embodiments of the present invention.

The mediation method for performing synchronization between devices according to various embodiments of the present invention may be realized as program instructions, which may be performed through various computer means, so that they may be recorded in a computer readable medium. The computer-readable medium may include a program command, a data file, and a data structure individually or a combination thereof. The program command recorded in the medium is designed and configured for the present invention, but may be used after being made known to those skilled in computer software fields.

Examples of the computer-readable recording medium include magnetic media such as hard disks, floppy disks and magnetic tapes, optical media such as a Compact Disc Read-Only Memory (CD-ROM) and a Digital Versatile Disc (DVD), magneto-optical media such as floppy disks, and hardware devices such as a Read-Only Memory (ROM), a Random Access Memory (RAM) and a flash memory, which are configured to store and perform program instructions. Examples of the program instructions include a machine language code generated by a compiler and a high-level language code that a computer can execute by using an interpreter and the like. The hardware devices may be configured to operate as at least one software module to perform the operations of the present invention, and vice versa.

As described above, although the present invention has described the specific matters such as concrete components, the limited embodiments and the drawings, they are provided merely to assist general understanding of the present invention and the present invention is not limited to the embodiments. Various modifications and changes can be made from the description by those skilled in the art.

Accordingly, the spirit and scope of the present invention should not be limited or determined by the above-described embodiments, and it should be noted that not only the claims which will be described below but also their equivalents fall within the spirit and scope of the present invention.

What is claimed is:

1. A method for synchronization between devices, comprising:
transmitting first synchronization request information by a mediation device to a first device, according to a first gesture of the mediation device with respect to the first device;
receiving by the mediation device, device identification information corresponding to the first synchronization request information from the first device; and
implementing synchronization between the first device and a second device through transmission of second synchronization request information to the second device by the mediation device, according to a second gesture of the mediation device with respect to the first device and the second device.

2. The method according to claim 1, wherein the first synchronization request information comprises master device setup confirmation information for setting the first device as a master device, and information for requesting address information of the first device.

3. The method according to claim 2, wherein the address information comprises one of a MAC address and Service Set IDentification (SSID) of a communication section of the first device.

4. The method according to claim 1, wherein the second synchronization request information comprises slave setup request information for setting the second device as a slave device, and device identification information of the first device.

5. The method according to claim 1, wherein the mediation device, the first device and the second device perform communication by using at least one communication scheme including Near Field Communication (NFC), Radio Frequency Identification (RFID), Wireless Personal Area Network (WPAN), RuBee, ZigBee, Ultra Wide Band (UWB), Bluetooth, WiFi-direct, and Infrared Data Association (IrDA).

6. The method according to claim 1, wherein at least one section of images displayed on a screen of the first device by the synchronization is displayed on a screen of the second device.

7. A method for synchronization between devices, comprising:
receiving first synchronization request information from a mediation device by a first device, according to a first gesture of the mediation device with respect to the first device;
transmitting, by the first device, device identification information of the first device to the mediation device in response to the first synchronization request information; and
transmitting images displayed on a screen of the first device to a second device, according to a second gesture of the mediation device with respect to the second device different from the first device, when synchronization between devices is implemented.

8. A method for synchronization between devices, comprising:
receiving second synchronization request information from a mediation device by a second device, according to a second gesture of the mediation device with respect to the second device, the second synchronization request information including device identification information obtained by the mediation device from a first device according to a first gesture of the mediation device with respect to the first device; and
receiving, from the first device, an image displayed on a screen of the first device by the second device using the second synchronization request information to thereby display the image on a screen of the second device.

9. An apparatus for mediating synchronization between devices comprising:
a short-distance communication section that implements wireless communication; and
a control section that transmits first synchronization request information to a first device through the short-distance communication section, receives device identification information from the first device, and transmits second synchronization request information to a second device after confirming the first device as a master device.

10. The apparatus according to claim 9, wherein the wireless communication is performed through at least one communication scheme including Near Field Communication (NFC), Radio Frequency Identification (RFID), Wireless Personal Area Network (WPAN), RuBee, ZigBee, Ultra Wide Band (UWB), Bluetooth, WiFi-direct, and Infrared Data Association (IrDA).

11. The apparatus according to claim 10, further comprising a gesture sensing section that senses a gesture by being provided with one of a geomagnetism sensor, an acceleration sensor, and a gravity sensor.

12. The apparatus according to claim 11, wherein the control section implements wireless communication after receiving information about the gesture from the gesture sensing section.

13. The apparatus according to claim 9, wherein the first synchronization request information transmitted to the first device comprises master device setup information that requests the first device to be set as a master device, and information that requests address information of the first device.

14. The apparatus according to claim 9, wherein the second synchronization request information transmitted to the second device comprises slave device setup information that requests the second device to be set as a slave device, and device identification information of the first device.

15. The apparatus according to claim 9, wherein the device identification information comprises master device setup confirmation information of the first device, and address information of a communication section of the first device.

16. The apparatus according to claim 13, wherein the address information comprises one of a Media Access Control (MAC) address and SSID of the communication section of the first device.

17. The apparatus according to claim 14, wherein the device identification information comprises master device setup confirmation information of the first device, and address information of a communication section of the first device.
